(19) United States
(12) Patent Application Publication
(10) Pub. No.: US 2016/0303945 A1
(43) Pub. Date: Oct. 20, 2016

(54) AIR-CONDITIONING SYSTEM FOR A MOTOR VEHICLE AND METHOD FOR OPERATING SAID AIR-CONDITIONING SYSTEM

(71) Applicant: VOLKSWAGEN AKTIENGESELLSCHAFT, Wolfsburg (DE)

(72) Inventors: Jan-Christoph ALBRECHT, Wolfsburg (DE); Cartsten WACHSMUTH, Lagesbuettel (DE); Nils VRIELINK, Edemissen (DE); Michael DOBMANN, Wolfsburg (DE)

(21) Appl. No.: 15/028,889

(22) PCT Filed: Apr. 15, 2014
(86) PCT No.: PCT/EP2014/057675

§ 371 Date: Jun. 10, 2016

(30) Foreign Application Priority Data
Jun. 8, 2013 (DE) 10 2013 009 712.6
Jan. 22, 2014 (DE) 10 2014 201 155.8

(51) Int. Cl. B60H 1/32; B60H 1/00; B60H 3/02

(52) U.S. Cl. CPC B60H 1/321; B60H 1/3227; B60H 3/024; B60H 1/00335; B60H 1/323; B60H 2001/3248; B60H 2001/3261; B60H 2001/3241; B60H 2001/3283; B60H 2001/327; B60H 2001/3266; B60H 2001/006

(57) ABSTRACT

The invention relates to an air-conditioning system for a motor vehicle, comprising a refrigerant circuit having at least one evaporator (16) configured as a refrigerant-air heat exchanger by means of which cooling air can be blown into an interior space of the motor vehicle by means of an air flow generating unit (12). The invention is characterized in that the evaporator (16) can be operated at a working temperature of less than 0° C.

The present invention relates to an air conditioning device for a motor vehicle, including a refrigerant circuit having at least one evaporator in the form of a refrigerant/air heat exchanger, via which cooling air is able to be blown by an airflow generator into a passenger compartment of the motor vehicle.

The present invention also relates to a method for operating such an air conditioning device.

Today's motor vehicles are normally equipped with air conditioning devices that blow a cooled air flow into the passenger compartment of a motor vehicle. These devices typically include a refrigerant circuit, within which a refrigerant passes cyclically through a sequence composed of a compressor, heat exchanger, pressure relief valve and evaporator. The refrigerant is compressed in the compressor. In a fluidically downstream heat exchanger, which is often in the form of a refrigerant-air heat exchanger or a refrigerant-water heat exchanger, the refrigerant, which is heated by the compression, is cooled and pressure-relieved by the fluidically downstream pressure relief valve. The cooled and pressure-relieved refrigerant subsequently passes through an evaporator where it is converted from the liquid to the gaseous state of aggregation. The evaporator is typically designed as a refrigerant-air heat exchanger that acts reciprocally with an air path in a heat exchanging process. The air path typically includes a blower that blows in cooling air through fins of the evaporator-heat exchanger and via a duct system into the passenger compartment of the motor vehicle. Upon passing through the evaporator heat exchanger, the air is notably cooled by the latent heat of evaporation of the evaporating refrigerant.

At a predetermined cooling air temperature, the cooling power derived for the passenger compartment of the motor vehicle essentially depends on the volumetric flow of the cooling air, which, in turn, depends on the channel cross section and the flow velocity of the cooling air. For the most part, the duct cross section is limited as a function of the space, so that a high cooling power is generally achieved by boosting blower operation in order to increase flow velocity. However, this is associated with higher noise levels in the passenger compartment. This must be considered to be disadvantageous.

It is an object of the present invention to provide an air conditioning device for a motor vehicle, as well as a method for the operation thereof, that will make possible a greater cooling power without increasing the noise levels in the passenger compartment or that will provide an enhanced noise quality at the same cooling power.

The objective is achieved in conjunction with the features set forth in the preamble of claim 1 in that the evaporator may be operated, respectively is operated at a working temperature of less than 0° C.

Other features and advantages constitute the subject matter of the dependent claims.

The idea underlying the present invention is to vary the cooling power not or at least not only by varying the volumetric flow of the cooling air, rather primarily through selection of the cooling air temperature. In particular, the present invention provides for operating the evaporator at especially low working temperatures in order to cool the cooling air to correspondingly low levels, notably to below 0° C. This requires blowing significantly less of such deeply cooled air into the passenger compartment to achieve a desired cooling power than in the case of conventional air conditioning devices. Namely, these conventional air conditioning devices prevent operation of the evaporator at a working temperature below the freezing point, because the moisture contained in the air thereby freezes on the evaporator-heat exchanger and clogs the flow-through fins thereof and/or degrades the thermal reciprocal action between the metallic heat-exchanger fins and the cooling air. In this case, one speaks of the evaporator-heat exchanger freezing up. The present invention defies this preconceived notion shared by experts in the field and deliberately provides an evaporator that may be operated below the freezing point. This may be readily realized by one skilled in the art, for example, through proper selection of a suitable refrigerant. Refrigerant having thermodynamic properties similar to R134a may be used, for example, to achieve working temperatures of down to −15° C. To achieve even lower temperatures of down to −30° C., for example, refrigerants having thermodynamic properties similar to R744 could be used.

It is self-evident that an air conditioning device according to the present invention must also contend with the icing problem explained above. Preferred specific embodiments of the present invention offer different conceptual approaches here.

A first preferred specific embodiment provides that the evaporator have two mutually independently operable evaporator segments that are traversable parallel to one another by the cooling air flow. In this connection, the following will refer to a split evaporator. Such a split evaporator is preferably operated in a way that allows only one first one of the evaporator segments to be operated in an evaporator mode at a working temperature of less than 0° C. during a first operating phase, while a second one of the evaporator segments, which had been operated in a preceding operating phase in the evaporator mode at a working temperature of less than 0° C., is operated in a defrosting mode. In other words, if high cooling powers are required, only a portion of the evaporator is operated in the evaporator mode to drastically cool the cooling air to below the freezing point. The above explained icing occurs during this evaporator mode, thereby degrading the effective cooling power in the passenger compartment. The evaporator mode in the iced evaporator portion may then be switched off by a suitable control, which is described further below, and the transfer made to the other non-iced portion of the evaporator. While this non-iced evaporator portion provides for a sufficient cooling power in the passenger compartment, the iced evaporator portion is operated in the defrosting mode and deiced.

This may be accomplished in different ways. It should generally suffice that no evaporation take place in the evaporator portion to be defrosted, and that the iced heat exchanger portion nevertheless be traversed by cooling air flow. Alternatively, the iced heat exchanger portion may also be purged with heated air or engine cooling water or electrically heated in order to induce an active defrosting process. In this case, it is favorable to provide adjustable air guide means upstream of the evaporator in the direction of the cooling air flow to prevent the particular iced heat exchanger portion from being traversed by cooling air flow. Otherwise, namely, heated cooling air would potentially be blown into the passenger compartment.

Another, likewise preferred variant provides that a dehumidification evaporator, which is likewise designed as a refrigerant-air heat exchanger and is operated at a working temperature of more than 0° C., be fluidically connected upstream of the evaporator in the direction of cooling air flow. There is no fundamental difference between the actual evaporator and the evaporator denoted here as dehumidification evaporator; the different designations are merely intended to better differentiate the elements by the primary functions thereof. The cooling air is already precooled by the dehumidification evaporator, thereby simultaneously leading to the dehumidification thereof. However, since the dehumidification evaporator is operated at a working temperature above the freezing point, there is no risk of an icing here. Since, at this point, the low-temperature evaporator is traversed by dehumidified air flow, the risk of icing thereof is considerably diminished. This at least makes it possible to significantly prolong the time period until the occurrence of an icing that considerably degrades the cooling power. The two evaporators may be separate devices or differently designed components of one and the same device.

In spite of the fact that the time period until the occurrence of critical icing prolongs the upstream dehumidification evaporator, it is not possible to completely rule it out. For that reason, an advantageous further refinement of the aforementioned inventive variant provides that the evaporator be designed to allow freezing air humidity to accumulate as snow. It is likewise expedient to optimize the evaporator to effect a slowest possible rise in the air-side pressure loss upon icing. This may be achieved in the same way as the snow-like icing, for example, by properly selecting the fin interspacing and orientation, louver pitch and length and/or the surface coating. Taking into account the space requirements and specifications relating to the operating states to be realized, one skilled in the art will be able to find an appropriate adjustment. Due to the larger surface area thereof, the snow-like ice formation has the advantage of being more readily defrosted in comparison to solid ice. Accordingly, shorter defrosting periods are required. This enhances the in-vehicle thermal comfort.

In accordance with a similar idea, a third, likewise preferred specific embodiment of the present invention provides that a sorption unit, which is traversed by cooling air flow, be fluidically disposed upstream of the evaporator in the direction of cooling air flow. Here, a sorption agent is understood to mean any substance that is able to draw moisture from the surrounding air. Silica gel is mentioned here purely exemplarily. Depending on the composition and consistency of the sorption agent specifically used, one skilled in the art may readily devise a cooling air flow-traversable unit that, on the one hand, induces a significant dehumidification of the cooling air and, on the other hand, does not substantially impede the cooling air flow. With regard to the effect of this dehumidification, reference is made to the above explanation.

Two or more of the above mentioned variants may also be jointly used in a combined specific embodiment of the present invention.

Alternatively or additionally to the above explained operating method that is specific to split evaporators, a method for operating all of the aforementioned variants may be provided where the evaporator is alternately operated in an evaporator mode at a working temperature of less than 0° C. and in a defrosting mode. The concept of the defrosting mode is to be understood in accordance with the above explanation. Specifically, for this alternating operating mode, it is possible to distinguish between two fundamentally possible method variants.

A first advantageous method variant provides that a control unit monitor an operating parameter of the air conditioning device and that, in response to reaching a predefined tolerance range limit of the parameter value of the monitored operating parameter, a changeover be initiated between the evaporator mode and the defrosting mode. For example, the parameter monitored for this purpose may be the temperature of the cooling air downstream of the evaporator, a pressure differential of the cooling air pressure across the evaporator, and/or a noise level of a blower regulated to maintain a constant pressure downstream of the evaporator. In the first-mentioned case of temperature monitoring, a rise in the cooling air temperature suggests an inefficient evaporator mode, which, in turn, may indicate an icing that has already progressed. Therefore, the rise in the cooling air temperature in the direction of flow downstream of the evaporator could induce a changeover from the evaporator mode to the defrosting mode. It is self-evident that this requires a suitably configured and programmed controlling device, which, in principle, however, is commonly available in the form of control units in motor vehicles. Alternatively or additionally to the explained temperature monitoring, the pressure differential of the cooling air pressure between a region directly upstream of and directly downstream of the evaporator (in the direction of the cooling air flow) may be used. This requires an appropriate differential pressure sensor or a pair of absolute pressure sensors. A rise in the differential pressure above a predefined threshold value signals a clogging of the evaporator-heat exchanger's interfin space with ice and may, therefore, usefully induce a changeover from the evaporator mode to the defrosting mode. Here, as well, the necessity of a suitably configured and programmed controlling device is self-evident. However, to achieve a constant cooling power in the passenger compartment, it appears to be even more advantageous to regulate the blower to ensure that a constant pressure prevails in the direction of the cooling air flow downstream of the evaporator. This ultimately corresponds to a constant volumetric flow of the cooling air in the passenger compartment. An increased icing of the evaporator-heat exchanger requires operating the blower at a higher power. This increases the noise level. This may be utilized as a critical operating parameter for changing over from the evaporator mode to the defrosting mode. For example, a two-, four- or six-decibel rise in level may be derived as a limiting value, in response to whose exceedance, the operating mode of the evaporator is changed over.

In the context of the three aforementioned variants, the selection of the limiting values may be fixed and stored in a memory, for example. However, it seems to be more advantageous for the tolerance range limits to each be computed on the basis of a plurality of current operating parameters. In particular, a fluid dynamics based mathematical model may be stored, that takes current parameters into account, such as vehicle speed, outside temperature, cooling-air flow velocity, etc., for example, and yields a setpoint value, respectively a setpoint value range therefrom for the monitored operating parameter. Thus, at high vehicle speeds, the noise level threshold value may turn out to be higher than at low vehicle speeds.

A greatly simplified variant of this specific embodiment, that eliminates the need for monitoring operating parameters, provides that a changeover between the evaporator mode and the defrosting mode take place in response to the elapsing of a predefined time period, the predefined time period being computed on the basis of a plurality of current operating parameters. Here as well, a fluid dynamics based mathematical model is derived that incorporates current operating parameters. This model makes it possible to predict the time period after which a no longer tolerable icing of the evaporator-heat exchanger is to be expected in the evaporator mode. The operating mode is changed over at that instant. This applies analogously to switching back from the defrosting mode to the evaporator mode. In this specific embodiment, there is no metrological testing of the actual icing.

Alternatively, or preferably additionally to the measures described above, it may be provided that motor vehicle operating parameters, which are independent of the air conditioning device, be included in the planning of the changeover of the operating phase between the evaporator mode and defrosting mode. This variant lends itself, in particular, to the air-conditioning compressor intermittently not having power, for example, in stop phases in the case of vehicles having an automatic start-stop system (or the manually activated equivalent thereof). For the most part, namely, the air-conditioning compressor is mechanically coupled to the crankshaft of the internal combustion engine and, therefore, generally functions only when the internal combustion engine is in operation. Therefore, in the case of conventional air conditioning devices, the air conditioning comfort may be significantly adversely affected during standstill phases of the internal combustion engine, which occur, in particular, for energy conservation reasons, for example during wait times at traffic lights or, in the case of hybrid vehicles, during electric operation. Therefore, when establishing the timing, it is advantageous when the current and/or an anticipated operating state of an air-conditioning compressor driven by an internal combustion engine, i.e., in particular, the current or anticipated operating state of the internal combustion engine itself, is included in the determination of the instant of a changeover between the evaporator mode and the defrosting mode. Namely, if the already required defrosting mode takes place during such standstill phases of the internal combustion engine, the cold stored in the accumulated ice may be used to bridge such phases. Thus, the ice serves as a latent cold store due to the phase transition between the states of aggregation.

Therefore, one preferred specific embodiment of the present invention provides that the defrosting mode be synchronized with standstill phases of the internal combustion engine. The concept of synchronization is thereby not to be narrowly understood in the sense of a precise clocking synchronization of defrosting and standstill phases. What is meant rather is that a future standstill phase of the combustion engine is anticipated, a tolerance range is specified for the threshold value of the monitored operating parameter, and the instant of the changeover of the operating mode is determined within the resulting tolerance range thereof in a way that allows the evaporator to be operated in the defrosting mode during the anticipated standstill phase. A resulting, temporal tolerance range for the changeover instant follows from the determination of the threshold values together with the respective tolerance ranges. This may be utilized to advance or delay a defrosting phase recognized as necessary in the future, to achieve a greatest possible overlapping with an anticipated standstill phase of the combustion engine, and to thereby bridge the phase that is critical under the aspects of in-vehicle thermal comfort. The specific timing is generally the result of weighing technical and comfort-related aspects and is realized as software rules in the corresponding control device.

The basic idea of using the ice as a latent store that unavoidably forms on the evaporator or evaporator segment which is operated below the freezing point, may also be utilized on the basis of a further energy conservation measure. It is provided that the evaporator or the evaporator segment be driven during an overrun phase of the internal combustion engine at a working temperature that is reduced in comparison to traction phases of the internal combustion engine. This preferably occurs by suitably increasing the power used to drive the air-conditioning compressor, for example, by increasing the stroke thereof, and may occur both during pure overrun phases, as well as during combined braking and overrun phases. On the one hand, the air-conditioning compressor thereby contributes to a desired speed reduction of the vehicle; on the other hand, the ice formation and the cold storage in a latent store is thereby forced. As explained above, the thus recuperated kinetic energy of the vehicle may be utilized through proper time management when the evaporator mode and the defrosting mode phases are controlled to bridge critical air-conditioning phases. To maintain the air-conditioning performance in the passenger compartment during the recuperation phases, the blower speed is preferably correspondingly reduced during this process.

One skilled in the art does, in fact, generally know of the use of latent stores in connection with air conditioning devices; however, they require using all additional storage elements in the path of the air. Besides the associated space, weight and cost disadvantages, it is also problematic that these elements are charged and discharged in the summer and in the winter. This may delay the heating of the passenger compartment, especially in the winter, without any benefit to the cooling that is not needed anyway during this season. In contrast, the present invention provides that the ice from the completely frozen air humidity be utilized in accordance with the demand.

Other features and advantages of the present invention will be apparent from the following special description and drawings, in which:

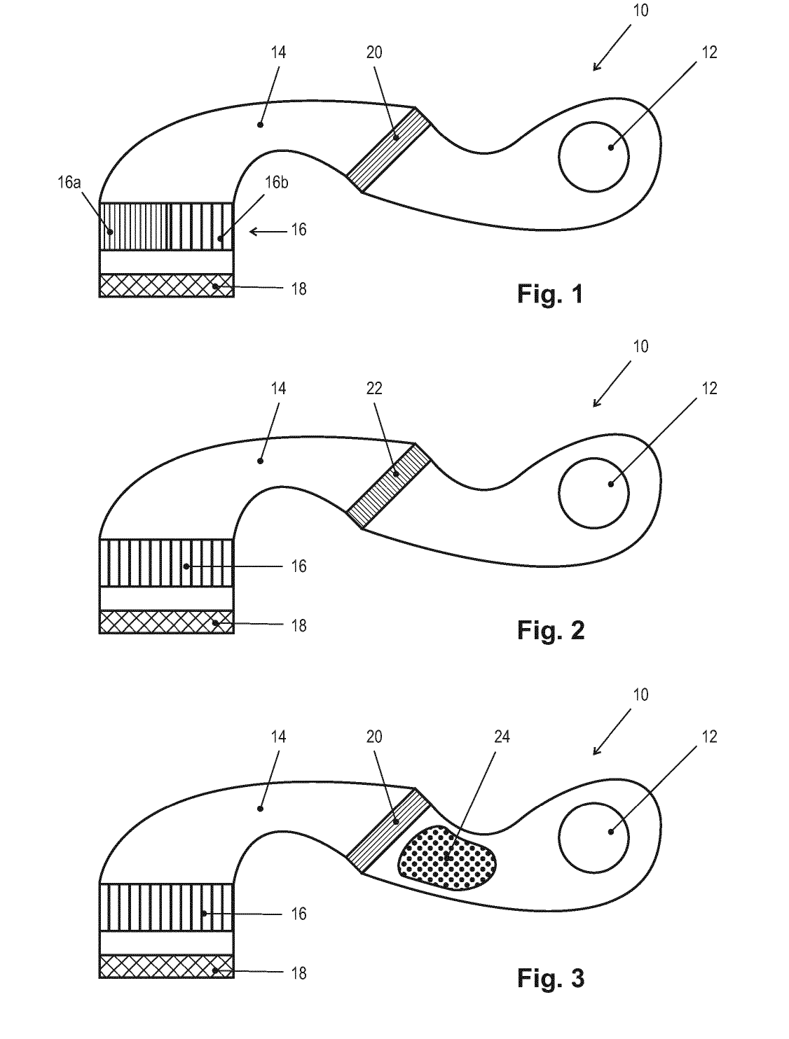

FIG. 1 is a schematic view of a first specific embodiment of the air conditioning device according to the present invention;

FIG. 2 is a schematic view of a second specific embodiment of the air conditioning device according to the present invention;

FIG. 3 is a schematic view of a third specific embodiment of the air conditioning device according to the present invention;

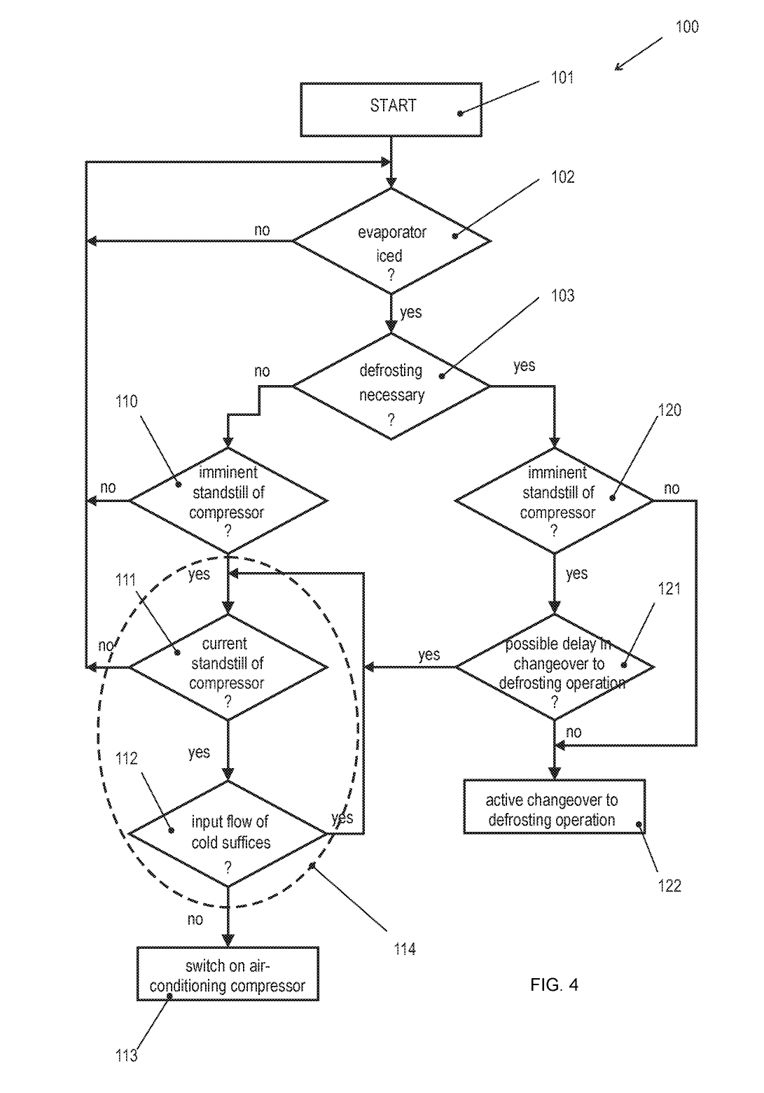

FIG. 4 is a flow chart of a preferred specific embodiment of a method for driving an air conditioning device according to the present invention.

Identical reference numerals in the figures indicate the same or analogous elements.

In a highly schematic view, FIG. 1 through 3 each show an air conditioning device 10 for a motor vehicle. It includes a blower 12, via which cooling air may be blown through a duct system 14 into a passenger compartment (not shown) of a motor vehicle. The cooling air thereby passes through an evaporator 16 of a refrigerant circuit (also not shown). In this instance, evaporator 16 is designed as a refrigerant-air heat exchanger. It preferably has a fin-like structure, which is traversed by cooling air flow and is in close thermal contact with the refrigerant that is evaporated in evaporator 16. Thus, the cooling air is cooled in response to passage thereof through evaporator 16.

In the illustrated specific embodiments, a heat exchanger 18 is connected downstream of evaporator 16 in the direction of the cooling air flow. In some instances, heat exchanger 18 is used for counter heating the cooling air when a less deeply cooled cooling air flow is desired in the passenger compartment. Heat exchanger 18, which is, therefore, only activated as needed in special cases, is not essential to the present invention.

The above explanations relate to all illustrated specific embodiments whose differences are to be described in detail in the following with reference to the individual figures. All three specific embodiments, whose differences are to be described in detail in the following with reference to the individual figures, have in common that evaporator 16 may be operated in each case at a working temperature below the freezing point, and is preferably operated this way, at least in response to a demand for an especially high cooling power in the passenger compartment. This may be realized, in particular by selecting a suitable refrigerant.

The specific embodiment in accordance with FIG. 1 is distinguished by a split evaporator 16. It includes two evaporator segments 16a, 16b, which are distinguished in FIG. 1 by different hatchings. There is no basic difference in design or function between the two evaporator segments 16a, 16b. However, both evaporator segments 16a, 16b may be operated independently of one another. As a preferred operating method, it is thus provided that only one of evaporator segments 16a, 16b be operated in the evaporator mode, in particular at a working temperature below the freezing point, while other evaporator segment 16b, 16a be inactive, but nevertheless be traversed by cooling air flow. Due to the moisture contained in the cooling air and operation below the freezing point, prolonged operation of active evaporator segment 16a, 16b will cause ice to accumulate on the fins thereof and increasingly displace the air passages between the same as the ice crystals grow. The reaching of a critical icing stage is either detected metrologically or computed on the basis of a fluid dynamics model and is assumed to be reached once a computed period of time has elapsed. Evaporator element 16a, 16b, which is active up to that point, is then inactivated, and evaporator element 16b, 16a, which is inactive up to that point, is then activated. The latter then analogously provides for a continuation of the cooling-air cooling. The now inactivated evaporator element 16a, 16b continues to be traversed by the flow of cooling air, which, upstream of evaporator 16, exhibits the ambient temperature, in particular has a temperature of above 0° C., and is thereby defrosted. The cooling air continues to undergo a cooling, although not to the extent experienced in the case of now activated evaporator segment 16b, 16a. This changeover of operating mode between evaporator segments 16a, 16b may be analogously continued alternatingly, the present invention not being limited to the use of exactly two evaporator segments. In this case, the air from the two evaporator segments may be mixed in a mixing chamber configured downstream in the direction of the cooling air flow. Alternatively, the air from the evaporator segment operated in the defrosting mode may also be expelled, which may be advantageous with regard to the comparatively high moisture content thereof.

In the specific embodiment shown in FIG. 1, a filter, which prevents or reduces a soiling of the evaporator fins, is placed upstream of evaporator 16 in the direction of flow.

FIG. 2 shows a specific embodiment having an undivided evaporator 16. Instead of filter 20 provided in the specific embodiment of FIG. 1, an additional evaporator, referred to here as dehumidification evaporator 22, is provided in the specific embodiment of FIG. 2. It is operated at a working temperature above the freezing point, preferably just above the freezing point. Dehumidification evaporator 22 is also designed as a refrigerant-air heat exchanger and cools the cooling air flowing through the same due to the thermal reciprocal action with the refrigerant, which is evaporated in the interior thereof and is conducted in a refrigerant circuit that is not described further. A secondary effect of this precooling is the dehumidification of the cooling air. In particular, the moisture contained in the warm cooling air is condensated out upon passing through the fins of dehumidification evaporator 22. Thus, dried and precooled cooling air is fed to actual evaporator 16. In comparison to an evaporator that is likewise operated at temperatures below the freezing point and is charged with air that is not dehumidified, there is correspondingly less icing risk, respectively there is a correspondingly longer period of time until icing of evaporator 16. Therefore, in most cases, this specific embodiment makes do entirely without defrosting management. In particular, it may be assumed that the evaporator mode of evaporator 16 is used at working temperatures below the freezing point only in those cases where a rapid cooling is desired. Also, for reasons of comfort, the operation at working temperatures below the freezing point is typically not a permanent condition. Critical icing is, therefore, more likely to be a rare occurrence. Nevertheless, a defrosting management may also be provided here that may be based on different principles (metrological monitoring or model-based time period computation). Unlike the specific embodiment of FIG. 1, the evaporator and defrosting modes would not alternate between the segments. Rather, entire evaporator 16 alternates as a function of time. Reference may be made in this regard to the above explanation.

It is self-evident that it is possible to combine the two aforementioned variants with one another, i.e., a split evaporator 16 with an upstream dehumidification evaporator 22.

Finally, FIG. 3 shows a specific embodiment of the present invention that includes an undivided evaporator 16 and that does not have a dehumidification evaporator 22. Rather, as in the specific embodiment of FIG. 1, a filter 20 is configured in duct system 14 and placed upstream of evaporator 16. A distinctive feature of the specific embodiment of FIG. 3 is that a sorption unit 24, which is traversed by cooling air flow and chemically dehumidifies the same, is configured in duct system 14. The special placement of sorption unit 24 upstream of filter 20, as shown in FIG. 3, is not absolutely essential. Rather, it may be provided at virtually any location within duct system 14. It is self-evident that the idea of sorption unit 24 within duct system 14 may also be combined with both aforementioned specific embodiments or a combination thereof.

FIG. 4 shows a flow chart of a preferred specific embodiment of a method 100 for controlling an air conditioning device according to the present invention with the aim of synchronizing defrosting mode phases and standstill phases of the compressor that typically accompany standstill phases of the combustion engine. Starting point 101 of the illustrated routine may be incorporated by one skilled in the art at any suitable point in the general controlling of the air conditioning device. Step 102 first checks whether the evaporator or an evaporator segment (both are referenced in the flow chart of FIG. 4, as well as in the subsequent description as “evaporator”) is currently iced. This may be measured by using a suitable sensor system, as described further above in greater detail.

If there is currently no icing of the evaporator, the process returns to a general icing monitoring routine. On the other hand, if the evaporator is iced, step 103 checks whether a defrosting is necessary. To this end, as described further above, various operating parameters of the air conditioning device are preferably measured and evaluated. In particular, the measured values are compared to stored or computed threshold values, which, however, are preferably not provided with exactly, but rather with suitably selected tolerance ranges. If it is ascertained in this case that a defrosting is not yet necessary, i.e., the measured operating parameter(s) is/are not yet within the tolerance range(s) around the corresponding threshold value(s), the left arm of the flow chart of FIG. 4 checks whether it is useful to shift a (passive) defrosting interval to an earlier time.

To this end, step 110 checks whether an imminent standstill of the air-conditioning compressor is anticipated. In particular, it may be checked whether an imminent standstill of the internal combustion engine, which drives the air-conditioning compressor, is to be anticipated. Driving parameters or measured values from an additional sensor system may be used for that purpose. For example, on the basis of Car2Car or Car2X communication, visual, camera-based driving environment monitoring, satellite-based traffic monitoring or, similarly, the traffic situation in the area surrounding the motor vehicle may be checked, and possible causes of an imminent vehicle stop, expected to lead to a temporary engine standstill due to an automatic start-stop system, may be analyzed. If no such imminent compressor, respectively engine standstill is to be anticipated, for example, because the motor vehicle is moving at a high velocity on a little traveled turnpike, the process returns to the monitoring routine.

However, if an imminent compressor, respectively engine standstill is to be anticipated, possibly after a wait for a specific time period, step 111 checks whether the compressor, respectively the engine is currently at a standstill. If this is not the case, the process returns to the monitoring routine.

Otherwise, it is determined, however, that the evaporator has made the transition to a passively initiated defrosting mode in response to the standstill of the compressor. This is characterized in FIG. 4 by a dashed-line oval and reference numeral 114. In the passively initiated defrosting mode, the cooling air flow continues to traverse the evaporator; in the interior thereof, refrigerant is no longer evaporated, however, since the air-conditioning compressor is at a standstill. Therefore, cooling air flow traversing the evaporator leads to a defrosting of the ice, extracting heat from the cooling air, so that cold is still input into the passenger compartment during a bridging phase.

Step 112 checks whether this inflow of cold suffices for maintaining the desired in-vehicle thermal comfort. To this end, a corresponding sensor system is preferably used in the passenger compartment or in the area of the cooling air outlet nozzles. If the inflow of cold suffices, the defrosting mode may be maintained. To this end, the process loops around steps 111 and 112. In particular, it is necessary to continue to monitor whether the compressor, respectively the engine is at a standstill or was restarted by the driver or the automatic start-stop system.

If, on the other hand, step 112 ascertains that the inflow of cold does not suffice for maintaining the desired thermal comfort in the passenger compartment, in particular because the ice forming the latent store has defrosted on the evaporator, the passive defrosting mode must be ended, and the air-conditioning compressor reactivated in step 113, which is possibly associated with a start of the combustion engine. It is self-evident that it is also possible to override step 113 and to accept reductions in in-vehicle thermal comfort with a view to saving energy.

However, if it is ascertained above in step 103 that it is necessary to defrost the evaporator, i.e., in particular that the monitored operating parameters have assumed parameter values that reside within the tolerance ranges around the corresponding threshold values, it is checked in the right branch of FIG. 4 whether it is practical to actively switch over to the defrosting mode. To this end, step 120 likewise checks whether an imminent standstill of the compressor, respectively of the engine is anticipated. For details, reference is made to the aforementioned regarding step 110. If no imminent standstill of the compressor, respectively of the engine is anticipated, an active changeover to the defrosting mode is required. The defrosting itself may either be carried out passively, simply by switching off the air-conditioning compressor, or actively, by additionally heating the evaporator either electrically or by using engine cooling liquid.

If, on the other hand, an imminent standstill of the compressor, respectively of the engine is anticipated in step 120, step 120 checks whether the changeover to the defrosting mode may be delayed in order to synchronize it with the anticipated standstill of the compressor, respectively of the engine. In particular, it is checked here whether the temporal tolerance range, derived from the tolerance range around the operating-parameter threshold values, has already been exhausted for the changeover to the defrosting mode. If this is the case, step 122 immediately requires actively making the transition to the defrosting mode in order to maintain the proper functioning of the air conditioning device.

However, if the temporal tolerance range is not yet exhausted, the switch may be made to the left branch of the flow chart of FIG. 4, already described above, and, in fact, in particular to step 111, i.e., to the passively initiated defrosting mode, for whose explanation, reference is made to the already aforementioned. If the anticipated standstill of the compressor, respectively of the engine takes place within the temporal tolerance range, the cold stored in the ice may be used to bridge the standstill phase. If, on the other hand, it does not occur or occurs too late due to incorrect anticipation, manual intervention by the driver, or suddenly changed traffic situation, i.e., after exhausting the temporal tolerance range, to the standstill of the compressor, respectively the engine; at the next pass, the method leads to step 122, i.e., to the active introduction of the defrosting mode.

It is self-evident that the specific embodiments discussed in the special description and shown in the figures only describe illustrative exemplary embodiments of the present invention. In light of the present disclosure, a broad spectrum of possible variations are made available to one skilled in the art.

### REFERENCE NUMERAL LIST

10 air conditioning device
12 blower
14 duct system
16 evaporator
16a,b evaporator segment
18 heat exchanger
20 filter
22 dehumidification evaporator
24 bsorption unit
100 control method
101, 102, 103,
111, 112, 113,
120, 121, 122
method steps of 100
114 passively introduced defrosting mode

1. An air conditioning device for a motor vehicle, comprising
a refrigerant circuit having at least one evaporator (16) in the form of a refrigerant/air heat exchanger, via which cooling air is able to be blown by an airflow generator (12) into a passenger compartment of the motor vehicle,
wherein the evaporator (16) can be operated at a working temperature of less than 0° C.

2. The air conditioning device as recited in claim 1, wherein the evaporator (16) has two mutually independently operable evaporator segments (16a, 16b) that are traversable parallel to one another by the cooling air flow.

3. The air conditioning device as recited in claim 1, wherein a dehumidification evaporator (22), which is designed as a refrigerant-air heat exchanger and is operated at a working temperature of more than 0° C., is fluidically connected upstream of the evaporator (16) in the direction of cooling air flow.

4. The air conditioning device as recited in claim 3, wherein the evaporator (16) is designed to allow freezing air humidity to accumulate as snow.

5. The air conditioning device as recited in claim 1, wherein a sorption unit (24), which is traversed by the cooling air flow, is fluidically disposed upstream of the evaporator (16) in the direction of cooling air flow.

6. A method for operating an air conditioning device (10) as recited in claim 2, comprising operating only one first one of the evaporator segments (16a, 16b) in an evaporator mode at a working temperature of less than 0° C. during an operating phase, while operating a second one of the evaporator segments (16b, 16a), which had been operated in a preceding operating phase in the evaporator mode at a working temperature of less than 0° C., in a defrosting mode.

7. The method as recited in claim 6, further comprising operating the evaporator (16) alternately in an evaporator mode at a working temperature of less than 0° C. and in a defrosting mode.

8. The method as recited in claim 7, further comprising monitoring, via a control unit, an operating parameter of the air conditioning device (10), and, in response to a predefined threshold value for the parameter value of the monitored operating parameter, initialing a changeover between the evaporator mode and the defrosting mode.

9. The method as recited in claim 8, wherein the monitored operating parameter is the temperature of the cooling air downstream of the evaporator (16), a pressure differential of the cooling air pressure across the evaporator (16), and/or a noise level of an airflow generator (12) regulated to maintain a constant pressure downstream of the evaporator (16).

10. The method as recited in either claim 8, wherein the threshold values are each computed on the basis of a plurality of current operating parameters.

11. The method as recited in claim 8, wherein the current and/or an anticipated operating state of an air-conditioning compressor driven by an internal combustion engine is included in the determination of the instant of a changeover between the evaporator mode and the defrosting mode.

12. The method as recited in claim 11, further comprising:
anticipating a future standstill phase of the combustion engine;
predefining a tolerance range for the threshold value of the monitored operating parameter; and
determining an instant of changeover of the operating mode within the resulting tolerance range thereof in a way that allows the evaporator to be operated in the defrosting mode during the anticipated standstill phase.

13. The method as recited in claim 1, further comprising controlling the evaporator or an evaporator segment during an overrun phase of the internal combustion engine at a working temperature that is reduced in comparison to traction phases of the internal combustion engine.

14. The method as recited in claim 7, wherein a changeover takes place between the evaporator mode and the defrosting mode in response to the elapsing of a predefined time period, the predefined time period being computed on the basis of a plurality of current operating parameters.
